(19) United States
(12) Patent Application Publication
(10) Pub. No.: US 2023/0336556 A1
(43) Pub. Date: Oct. 19, 2023

(54) MULTIUSER ACCESS RIGHTS FOR TRANSACTION MANAGEMENT

(71) Applicants: Joseph V. Coyne, Charlotte, NC (US); Hilani Kerr, San Francisco, CA (US); Jennel Ann McDonald, Oakland, CA (US); Madhumati Narasimhan, Pleasanton, CA (US); Pablo Simone, San Francisco, CA (US); Ashish Dilip Tengshe, San Ramon, CA (US)

(72) Inventors: Joseph V. Coyne, Charlotte, NC (US); Hilani Kerr, San Francisco, CA (US); Jennel Ann McDonald, Oakland, CA (US); Madhumati Narasimhan, Pleasanton, CA (US); Pablo Simone, San Francisco, CA (US); Ashish Dilip Tengshe, San Ramon, CA (US)

(21) Appl. No.: 18/300,951

(22) Filed: Apr. 14, 2023

Related U.S. Application Data
(60) Provisional application No. 63/363,083, filed on Apr. 15, 2022.

(51) Int. Cl. H04L 9/40; G06F 3/04817; H04L 51/224; H04L 51/04

(52) U.S. Cl. CPC H04L 63/101; G06F 3/04817; H04L 63/104; H04L 51/224; H04L 51/04

(57) ABSTRACT

A method may include receiving a request to create a stored group of users associated with a primary user, the primary user having a user profile stored on server device; in response, presenting a first user interface including a selection element configured to receive a selection of users to include in the stored group; and an input text element configured to receive a label for the stored group; based on data received in the selection element and input text element, generating the stored group; presenting a second user interface including: icon representations of each user in the stored group; and a selectable graphic element configured to present a permission modification interface; and in response to receiving input in the permission modification interface, updating access rights for an account of the accounts of the primary user.

### CLAIM OF PRIORITY

This patent application claims the benefit of U.S. Provisional Patent Application No. 63/363,083, titled “MULTIUSER ACCESS RIGHTS FOR TRANSACTION MANAGEMENT” filed Apr. 15, 2022, which is herein incorporated by reference in its entirety.

### BACKGROUND

Mobile apps and web-based applications allow a user to view information related to various aspects of a service. For example, a music application may allow a user to see the user's favorite musicians, or a financial application may allow for viewing an overview of the user's finances.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is an illustration of components of a client device and an application server, according to various examples.

FIG. 2 presents a series of user interfaces for viewing group profiles, in various examples.

FIG. 3A and FIG. 3B present a series of user interfaces for sharing of an individual goal, in various examples.

FIG. 4A and FIG. 4B present a series of user interfaces for sharing of a collaborative goal, in various examples.

FIG. 5 present a series of user interfaces to facilitate inheritance planning, according to various examples.

FIG. 6A and FIG. 6B present a series of user interfaces to facilitate a money mentorship experience, according to various examples

FIG. 7 is a flowchart illustrating operations of a method to generate group access rights for an account, according to various examples.

FIG. 8 is a block diagram illustrating an example machine upon which any one or more of the techniques (e.g., methodologies) discussed herein may be performed, according to an example embodiment.

### DETAILED DESCRIPTION

Traditional banking is often a singular experience. For example, a user may open a mobile banking application and transfer money or change their investments. With the exception of potentially talking with a financial advisor or chatbot, there is often no messaging/interaction between a user and their friends or family within the application itself. Described herein are new methods and systems for multiplayer banking services-discussed in terms of a mobile application but may be applicable to other platforms as well.

The other “players” in the discussed examples may be friends, family members, members of social circles (e.g., sports team members), or employer/employee groups. For example, a user may create a group to contribute to the user's savings goal, create a group with a shared goal, create a group to provide input on inheritance planning, or create a group for financial mentorship of the user. These scenarios are discussed in more detail below.

The described scenarios allow users to have precise and transparent control over what is shared and with whom. The system ensures privacy, transparency, and complete security in every exchange and transaction. The system further allows users to visualize the connections between the money a user has in different places, and how their financial network intersects with others in their defined groups and circles.

In the following description, for purposes of explanation, numerous specific details are set forth in order to provide a thorough understanding of some example embodiments. It will be evident, however, to one skilled in the art that the present invention may be practiced without these specific details.

Throughout this disclosure, electronic actions may be taken by components in response to different variable values (e.g., thresholds, user preferences, etc.). As a matter of convenience, this disclosure does not always detail where the variables are stored or how they are retrieved. In such instances, it may be assumed that the variables are stored on a storage device (e.g., RAM, cache, hard drive) accessible by the component via an API or other program communication method. Similarly, the variables may be assumed to have default values should a specific value not be described. User interfaces may be provided for an end-user or administrator to edit the variable values in some instances.

In various examples described herein, user interfaces are described as being presented to a computing device. Presentation may include transmitting data (e.g., a hypertext markup language file) from a first device (such as a web server) to the computing device for rendering on a display device of the computing device via a rendering engine such as a web browser. Presenting may separately (or in addition to the previous data transmission) include an application (e.g., a stand-alone application) on the computing device generating and rendering the user interface on a display device of the computing device without receiving data from a server.

Furthermore, the user interfaces are often described as having different portions or elements. Although in some examples these portions may be displayed on a screen at the same time, in other examples the portions/elements may be displayed on separate screens such that not all of the portions/elements are displayed simultaneously. Unless indicated as such, the use of “presenting a user interface” does not infer either one of these options.

Additionally, the elements and portions are sometimes described as being configured for a certain purpose. For example, an input element may be described as being configured to receive an input string. In this context, “configured to” may mean presentation of a user interface element that is capable of receiving user input. Thus, the input element may be an empty text box or a drop-down menu, among others. “Configured to” may additionally mean computer executable code processes interactions with the element/portion based on an event handler. Thus, a “search” button element may be configured to pass text received in the input element to a search routine that formats and executes a structured query language (SQL) query with respect to a database.

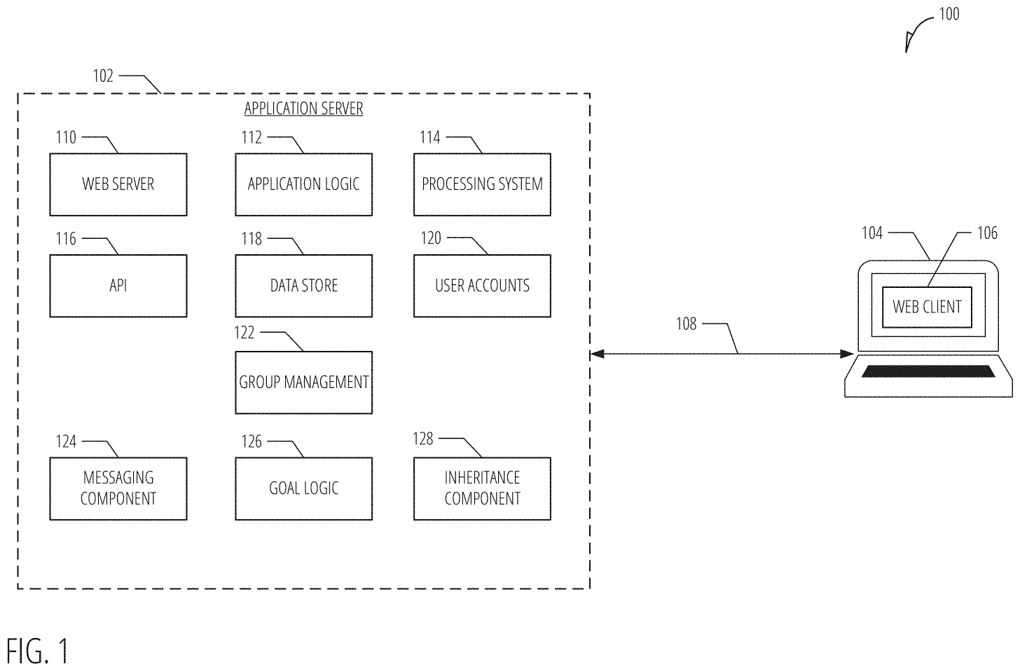

FIG. 1 is an illustration 100 of components of a client device 104 and an application server 102, according to various examples. Application server 102 includes web server 110, application logic 112, processing system 114, application programming interface (API) 116, data store 118, user accounts 120, group management 122, a messaging component 124, goal logic 126, and inheritance component 128.

Application server 102 is illustrated as set of separate elements (e.g., components, logic, etc.). However, the functionality of multiple, individual elements may be performed by a single element. An element may represent computer program code that is executable by processing system 114. The program code may be stored on a storage device (e.g., data store 118) and loaded into a memory of the processing system 114 for execution. Portions of the program code may be executed in a parallel across multiple processing units (e.g., a core of a general purpose computer processor, a graphical processing unit, an application specific integrated circuit, etc.) of processing system 114. Execution of the code may be performed on a single device or distributed across multiple devices. In some examples, the program code may be executed on a cloud platform (e.g., MICROSOFT AZURE® and AMAZON EC2®) using shared computing infrastructure.

Client device 104 may be a computing device which may be, but is not limited to, a smartphone, tablet, laptop, multi-processor system, microprocessor-based or programmable consumer electronics, game console, set-top box, or other device that a user utilizes to communicate over a network. In various examples, a computing device includes a display module (not shown) to display information (e.g., in the form of specially configured user interfaces). In some embodiments, computing devices may comprise one or more of a touch screen, camera, keyboard, microphone, or Global Positioning System (GPS) device.

Client device 104 and Application server 102 may communicate via a network (not shown). The network may include local-area networks (LAN), wide-area networks (WAN), wireless networks (e.g., 802.11 or cellular network), the Public Switched Telephone Network (PSTN) Network, ad hoc networks, cellular, personal area networks or peer-to-peer (e.g., Bluetooth®, Wi-Fi Direct), or other combinations or permutations of network protocols and network types. The network may include a single Local Area Network (LAN) or Wide-Area Network (WAN), or combinations of LAN's or WAN's, such as the Internet.

Client device 104 and application server 102 may communicate data 108 over the network. Data 108 may include requests to create of modify groups, view account data, a request to another user, among other items as discussed further herein.

In some examples, the communication may occur using an application programming interface (API) such as API 116. An API provides a method for computing processes to exchange data. A web-based API (e.g., API 116) may permit communications between two or more computing devices such as a client and a server. The API may define a set of HTTP calls according to Representational State Transfer (RESTful) practices. For examples, A RESTful API may define various GET, PUT, POST, DELETE methods to create, replace, update, and delete data stored in a database (e.g., data store 118)

Application server 102 may include web server 110 to enable data exchanges with client device 104 via web client 106. Although generally discussed in the context of delivering webpages via the Hypertext Transfer Protocol (HTTP), other network protocols may be utilized by web server 110 (e.g., File Transfer Protocol, Telnet, Secure Shell, etc.). A user may enter in a uniform resource identifier (URI) into web client 106 (e.g., the INTERNET EXPLORER® web browser by Microsoft Corporation or SAFARI® web browser by Apple Inc.) that corresponds to the logical location (e.g., an Internet Protocol address) of web server 110. In response, web server 110 may transmit a web page that is rendered on a display device of a client device (e.g., a mobile phone, desktop computer, etc.).

Additionally, web server 110 may enable a user to interact with one or more web applications provided in a transmitted web page. A web application may provide user interface (UI) components that are rendered on a display device of client device 104. The user may interact (e.g., select, move, enter text into) with the UI components, and, based on the interaction, the web application may update one or more portions of the web page. A web application may be executed in whole, or in part, locally on client device 104. The web application may populate the UI components with data from external sources or internal sources (e.g., data store 118) in various examples.

In various examples, the web application is a dynamic user interface that enables a user to create/modify groups, goals, and message between members of a group. More details and example interfaces of the web application are presented in the following figures.

The web application may be executed according to application logic 112. Application logic 112 may use the various elements of application server 102 to implement the web application. For example, application logic 112 may issue API calls to retrieve or store data from data store 118 and transmit it for display on client device 104. Similarly, data entered by a user into a UI component may be transmitted using API 116 back to the Web Server. Application logic 112 may use other elements (e.g., group management 122, messaging component 124, goal logic 126, inheritance component 128) of application server 102 to perform functionality associated with the web application as described further herein.

Data store 118 may store data that is used by application server 102. Data store 118 is depicted as singular element but may in actuality be multiple data stores. The specific storage layout and model used in by data store 118 may take a number of forms-indeed, a data store 118 may utilize multiple models. Data store 118 may be, but is not limited to, a relational database (e.g., SQL), non-relational database (NoSQL) a flat file database, object model, document details model, graph database, shared ledger (e.g., blockchain), or a file system hierarchy. Data store 118 may store data on one or more storage devices (e.g., a hard disk, random access memory (RAM), etc.). The storage devices may be in standalone arrays, part of one or more servers, and may be located in one or more geographic areas.

User accounts 120 may include user profiles on users of application server 102. A user profile may include credential information such as a username and hash of a password. A user may enter in their username and plaintext password to a login page of application server 102 to view their user profile information or interfaces presented by application server 102 in various examples.

A user profile may also include authorization to access other services in which the user has an account. The authorizations may include a token (e.g., using OAuth) or login credentials that authorize application server 102 to retrieve data from the other services in a defined format such as JavaScript Object Notation (JSON) or extensible markup language (XML) over an API. A reciprocal authorization may also be stored in the user profile that authorizes the other services to access data stored in the user profile. The user profile may also allow for viewing and editing of permissions for any accounts or groups that have been granted access to the primary account (e.g., the one with the user profile in this context).

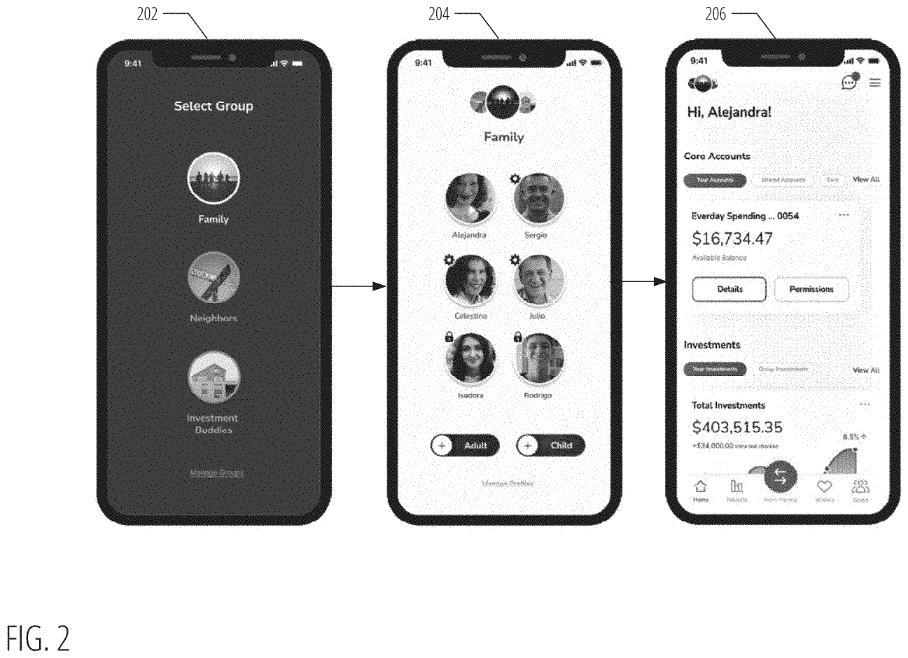

In various examples, a user profile may also identify (e.g., stored as entries in a table of a database) the groups that the user is a part. Group management 122 may present interfaces to manage the groups of a user as discussed with respect to FIG. 2. The remaining components-messaging component 124, goal logic 126, and inheritance component 128, are discussed in the context of the remaining figures.

The user profile may identify financial institution accounts of the user, access rights to the accounts, balances of the accounts, and transaction history of the accounts, in various examples. The user profile may also identify devices for which to receive notifications on (e.g., a mobile phone).

FIG. 2 is a series of user interfaces for viewing group profiles, in various examples. One of the features of a multiuser user experience is the groups. The interfaces of FIG. 2 illustrate ways to create trusted groups that can manage money together, whether that's family, friends, business partners, or beyond. Users can customize permissions to specify accessibility across accounts and individuals within their groups. Permissions may include, but are not limited to, read access, contribution access, and management (and withdraw) access. The permissions may be granular enough to permit different permissions for different users on different accounts or created goals. For example, while a partner might have access to selected accounts, others might have “view only” access. A user can be part of multiple groups as well—each with different access rights. The permissions may be stored as values in a database (e.g., in data store 118)

In some examples, a user does not need to have a financial account with a financial institution to be a member of a group. For example, a user may grant read-only access to a friend to allow for the friend to give advice through in-app messaging. In these instances, the user with the read-access rights may be identified using a email address and password.

FIG. 2 and the other user interface figures use a running example scenario with a fictional family as follows. Alejandra is from a large family where everyone does everything together and knows everything about each other. She is the oldest of five siblings and has two kids of her own, Rodrigo and Isadora. Her parents, Julio and Celestina, are first generation immigrants who came to America and opened several successful businesses. Alejandra is busy with a high-profile career, but she is also her family's connector, keeping everyone in the loop and organized. Julio and Celestina have recently retired and are now focused on passing on their legacy—their values and their inheritance—to their kids and grandkids.

Meanwhile, Alejandra's son Rodrigo is starting to think about college. It was important to Alejandra and her husband Sergio that their kids develop financial independence so each of them has been responsible for setting aside some money for college, although they will be happy to support their education as well. Recently, Alejandra learned that her bank has a new offering for groups—she immediately signs up and invites her kids and parents to figure out how the platform works. She's already thinking about inviting her siblings to simplify their joint endeavors—their group travel, reunions, investments, and beyond.

Interface 202, interface 204, and interface 206 may be from the perspective of Alejandra using a mobile application. Interface 202 presents a group selection screen. It allows Alejandra to connect and view selected members' accounts and goals to stay up to date on how others are doing. She also created groups with neighbors and her college friends who all have an interest in exploring and potentially collaborating on financial decisions/investments.

Interface 204 is a view of the members of her family group. There are user interface elements (gear icons) to edit permissions of some of the members whereas her kids' profiles are locked. There are also user interface elements to add adult or child members to the group. A child profile may automatically have certain permissions attached to that allow the child's parents to manage the profile. When adding a member, an invite may be sent to the potential member using an e-mail address if the member does not already have an account, or via the in-app messaging (e.g., using messaging component 124) client if the member has an account. The access rights and members of the group may be stored as part of a user account in data store 118. The functionality of group management may be performed by group management 122.

Interface 206 presents an overview of Alejandra's financial accounts. The bottom bar of interface 206 indicates functionality of the mobile application such as projects, transferring money, wishes, and goals. By taking a glance at this financial snapshot, a user may see where their accounts and investments stand. A user may also see certain family members' accounts if they have given them access. And the user may navigate and explore other groups that are sharing their stories and are open to collaborating.

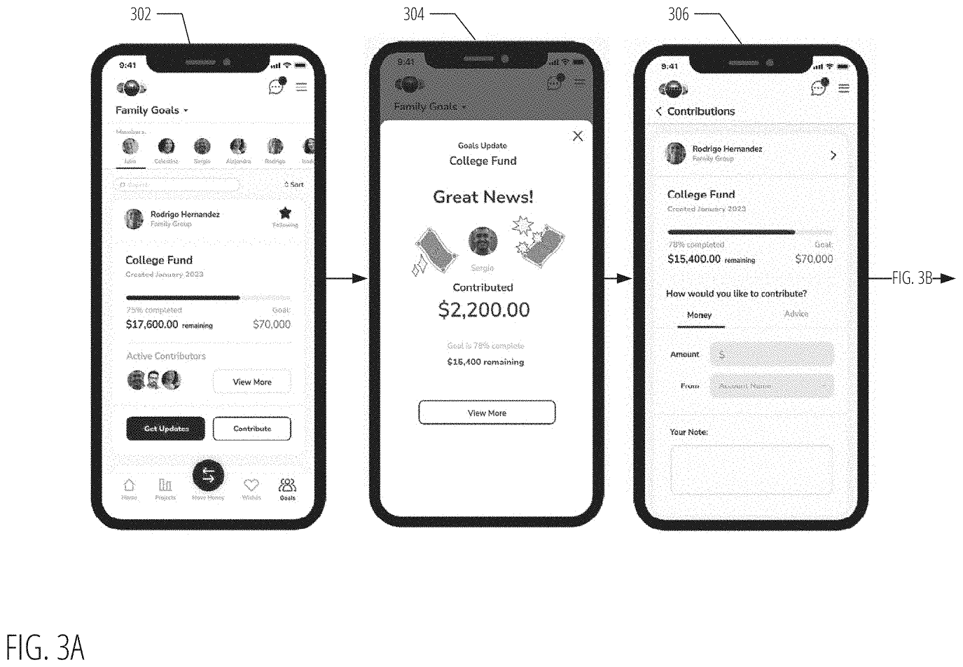

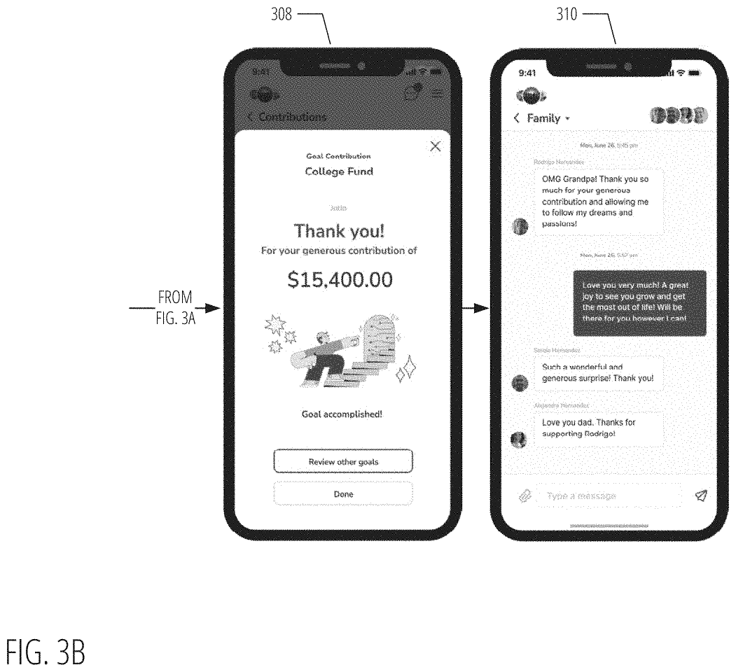

FIG. 3A and FIG. 3B present a series of user interfaces for sharing of an individual goal, in various examples. When a user creates a goal (e.g., such as by using goal logic 126), other users in a group may follow, contribute to, and receive updates on the user's progress. A group chat may be used to facilitate connections and conversations for a goal. Machine learning models may be used to bring up what is most important to a user based on past views and contributions to other goals. The user interfaces in FIG. 3A and FIG. 3B may be from the perspective of Julio monitoring the progress of his grandson's, Rodrigo, college fund goal.

Interface 302 presents an overview interface of Rodrigo's college fund goal. It illustrates the progress, the owner, a user interface element (the star) indicating Julio is following the goal, and the active contributors. Julio is also presented with options to get updates on the goal as well as contribute himself.

At interface 304, it may be noted that Sergio has contributed $2200 to the goal, and additional information is presented that indicates how much in terms of percentage and nominal dollar amount is remaining for the goal. An interface such as interface 304 may be presented as a push notification to Julio, in some examples, or by selecting the “get updates button” on interface 302.

Continuing to interface 306, a new user interface is presented that is configured to permit Julio to make contribution to his grandson's fund. Interface 306 may be presented in response to clicking the contribute button from interface 302. Interface 306 presents an overview of the goal, as well as an option to transfer money. An amount field and a dropdown account selection field may be presented. Furthermore, a notes field may be presented that allows Julio to send a message to the group about his contribution.

Interface 308 presents a confirmation message of the transfer and an indication that the goal has been accomplished. Interface 310 is an example group chat in which the group members can discuss the contribution and congratulate Rodrigo on his goal's accomplishment. In various examples, application server 102 may present opportunities to the group with respect to opening a 529 plan for the contributed amounts.

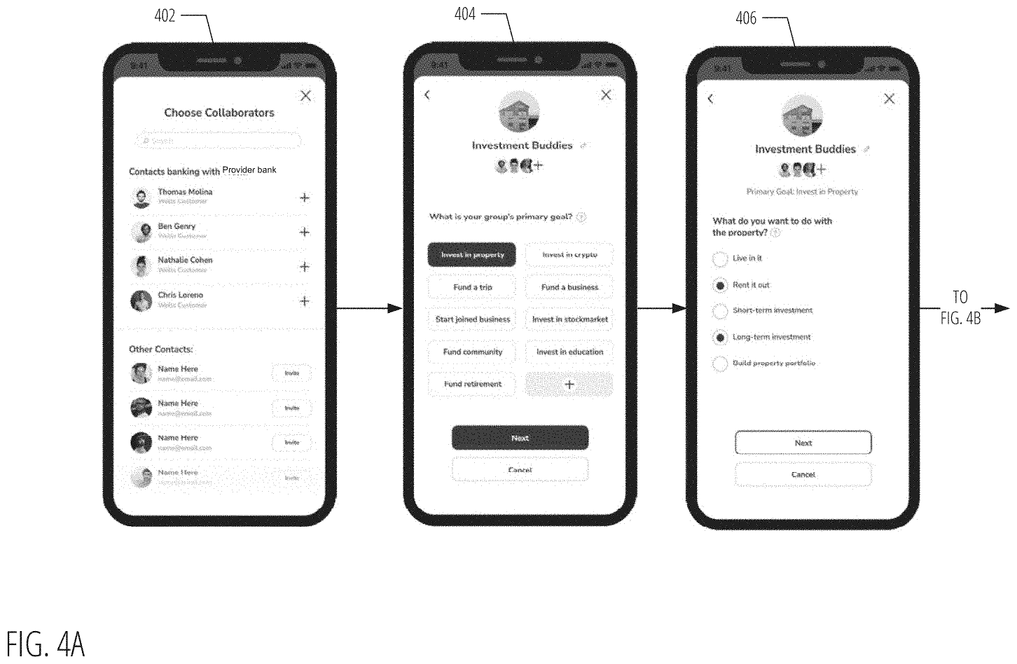

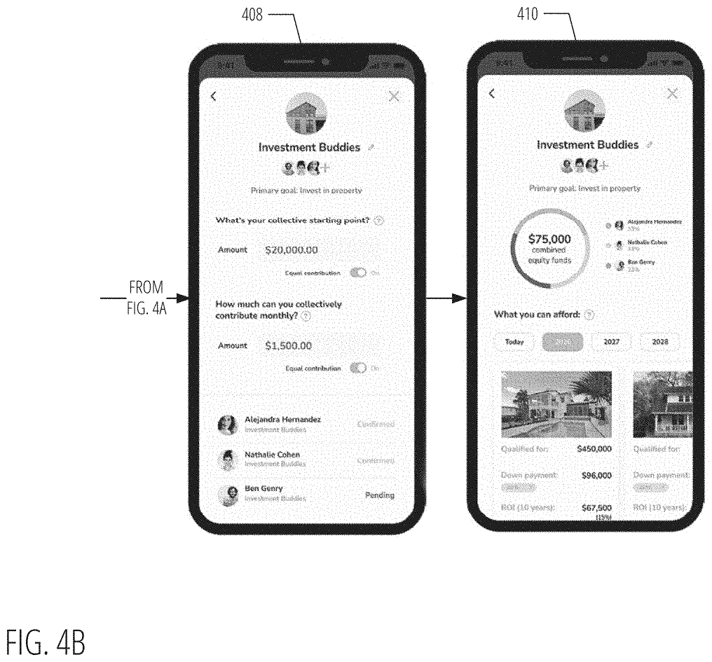

FIG. 4A and FIG. 4B present a series of user interfaces for sharing of a collaborative goal, in various examples. Collaborative goals may take many forms such as traditional money management, investing, small businesses, caregiving, group activities, group trips, sports team groups, etc.

A collaborative goal may allow users to individually contribute and track progress together. Each user in a group may contribute different amounts. The goal may be set up such that there are schedules to giving, and everyone does not need to contribute the same amount at the same time period. Furthermore, users that do not have accounts with the same financial institution that is providing the goal tracking may be invited to collaborate with those members with accounts. Additionally, the interfaces may present predictions and informed investment decisions based on machine learning models that have analyzed datasets as well as past behavior of group members.

Interface 402 is an interface that allows a set of collaborators to be created for a common purpose (e.g., using goal logic 126). As seen, there are two lists of potential collaborators. First, there are those users that have accounts already and second, a list of members that do not have accounts but may be invited to join a group. In this example, Alejandra and a couple of her friends have been talking about going in on a vacation property together for a while, so she decides to set up a group to start putting the idea into action.

Interface 404 allows for selection of one or more goals for the collaborative group. In this case, “invest in property” has been selected. Other options may be managing general finances, pooling for events, investing, caretaking, family businesses caretaking, etc.

Interface 406 is based on the selections made in interface 404 (e.g., using a lookup table as stored in data store 118). There may be several reasons behind the decision to invest in property. For example, a user/group may want to live in the property, rent it out, or be a short- or long-term investment. Another option presented is to build a property portfolio. One or more of these selections may be made by the user. The options presented in interface 404 and 406 may be used to inform recommendations and advice presented within the application.

An interface such as interface 408 may be presented after the purpose of the collaborative goal and invites have been sent out. Interface 408 may be an overview interview of the initial collaborative goal. For example, it may indicate what is the starting point (in this case $20,000) with an equal contribution toggle turned on. Separately, there may be a personal indication of how much Alejandra can contribute monthly, which in this case is $1500. Furthermore, the bottom portion of interface 408 indicates the status of invites that have been sent out for participation within the group.

After everyone has accepted or declined the invitation (e.g., as determined by a user affirmatively clicking a button in the request, etc.), interface 410 may be presented that indicates the goal is active and presents an overview of the status of the goal. In this case, there are three members which have all collectively contributed $75,000. Application server 102 may present opportunities with respect to the goal. Accordingly, interface 410 presents several properties based on what the group can afford. In various examples, application server 102 may present opportunities to the group with respect to opening accounts or applying for loans to help purchase a presented property.

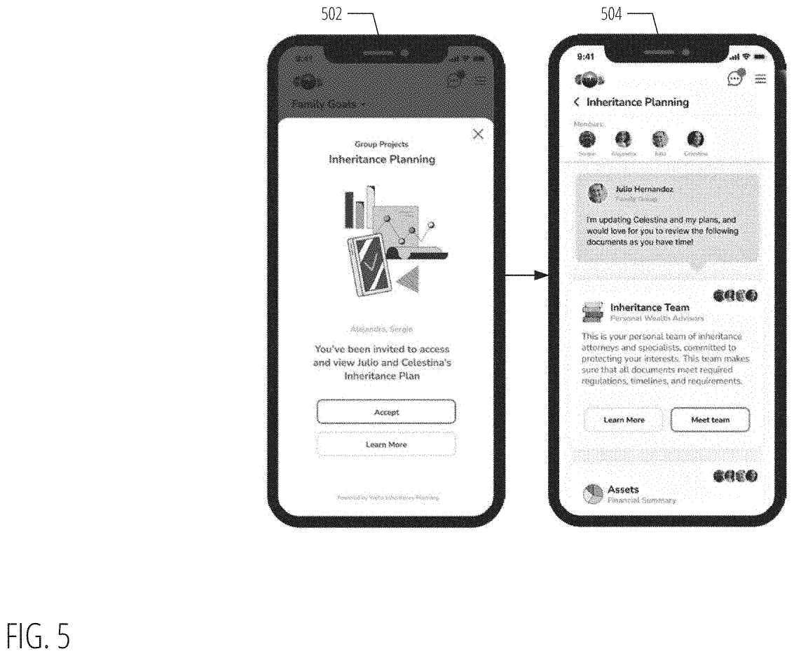

FIG. 5 present a series of user interfaces to facilitate inheritance planning, according to various examples. Application server 102 may provide tools (e.g., inheritance component 128) to create an inheritance plan and share it within families. In other examples, a user may already have accounts/inheritance plans with other vendors. The user may grant access to these accounts such that other users that have been invited to view the inheritance plan may do so. Application server 102 may store any documents related to the inheritance plan, such as trust documents, and the user may grant access to download or read the documents selectively to other family members. Furthermore, the inheritance planning tools may allow a user to ask for advice from other family members or connect with an advisor at a financial institution using the in-app messaging (e.g., messaging component 124).

Interface 502 and interface 504 are presented from the perspective of Sergio. An interface 502 of an invitation screen is presented to Sergio to access Julio and Celestina's inheritance plan. The plan may have been created with advisors associated with application server 102 or their own planners. The documents created for the plan may be stored and accessed by Sergio upon accepting the invitation.

Interface 504 is an interface that may be presented after accepting the invitation. In this interface, Alejandra and Sergio are able to learn and review decisions that have been made on the permission Julio and Celestina have set in place. As can be seen, there is a portion of interface 504 that allows connecting with the inheritance team of Celestina and Julio, and a portion that allows viewing of assets of Celestina and Julio.

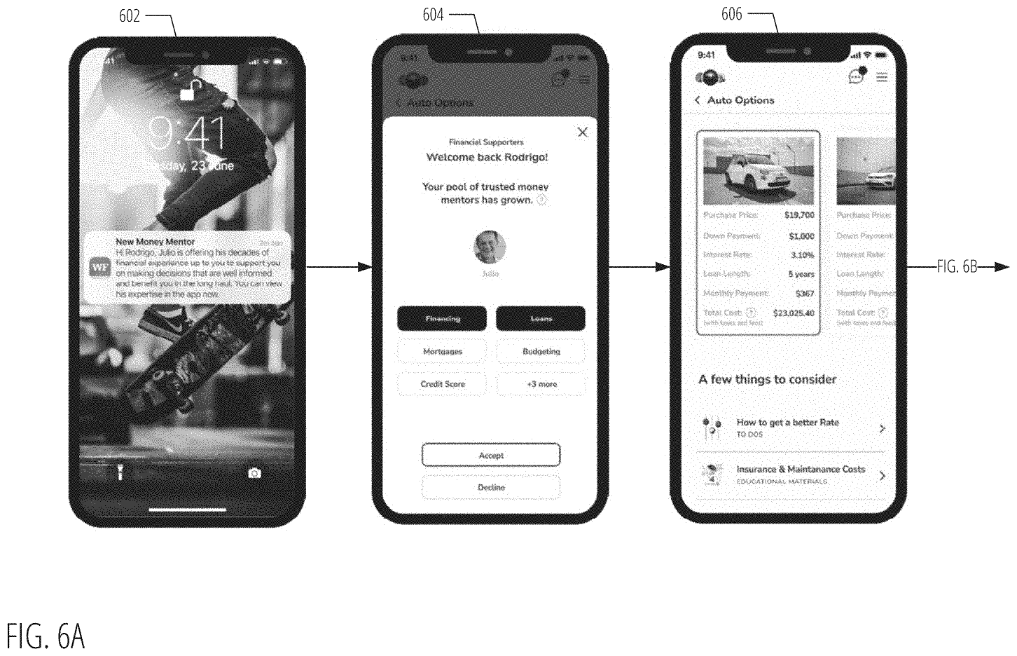

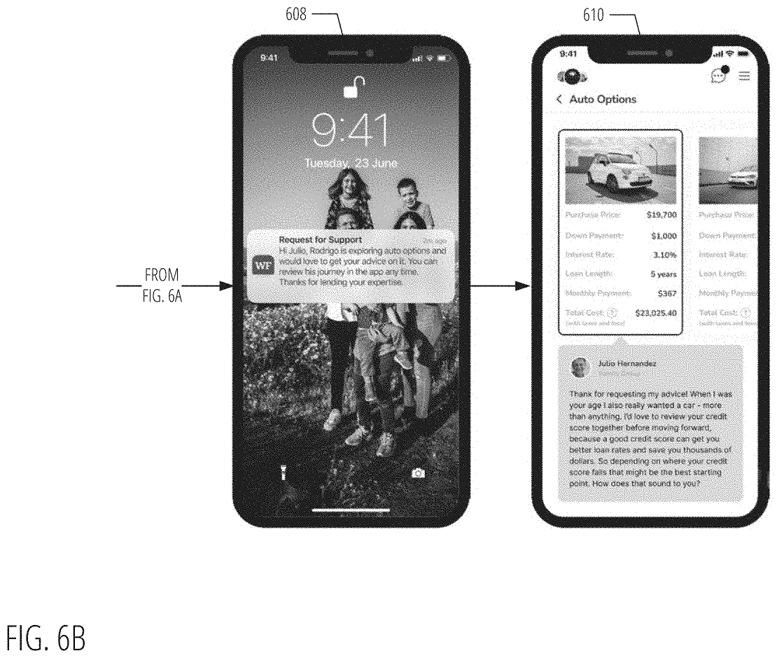

FIG. 6A and FIG. 6B present a series of user interfaces to facilitate a money mentorship experience, according to various examples. Another feature provided by application logic 112 is mentorship. Mentorship may allow selection of a “money mentor” (trusted family members or friends) who act as advisors. Once connected, messages may be sent between the mentor and mentee of updates and notifications related to financial matters. FIG. 6A is presented from the perspective of Rodrigo and FIG. 6B is Julio's viewpoint.

At interface 602, a message is received from Julio offering to be Rodrigo's mentor. Interface 604 may be presented upon Rodrigo selecting the push notification to view more information on Julio's offer. As can be seen, Julio is offering his advice on financing and loans, and an option is presented to accept or decline Julio is offer. In this scenario, Rodrigo accepts Julio's offer.

Now that Rodrigo is able to obtain Julio's advice, interface 606 shows Rodrigo sending an auto loan profile for Julio to review. Interface 606 also includes generated research tips for Rodrigo related to auto loans, such as how to get a better rate, as well as insurance and maintenance costs related to vehicle ownership.

In interface 608, Julio receives a push notification indicating that Rodrigo would like his advice related to an automobile purchase. Upon selecting the push notification, interface 610 may be presented which shows the automobile that Rodrigo was considering purchasing. Julio provides a response indicating his advice. Although not illustrated as such, Julio may also record a video or audio message for Rodrigo to view at a later time.

Embodiments described herein may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules may be hardware, software, or firmware communicatively coupled to one or more processors in order to carry out the operations described herein. Modules may hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium.

In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

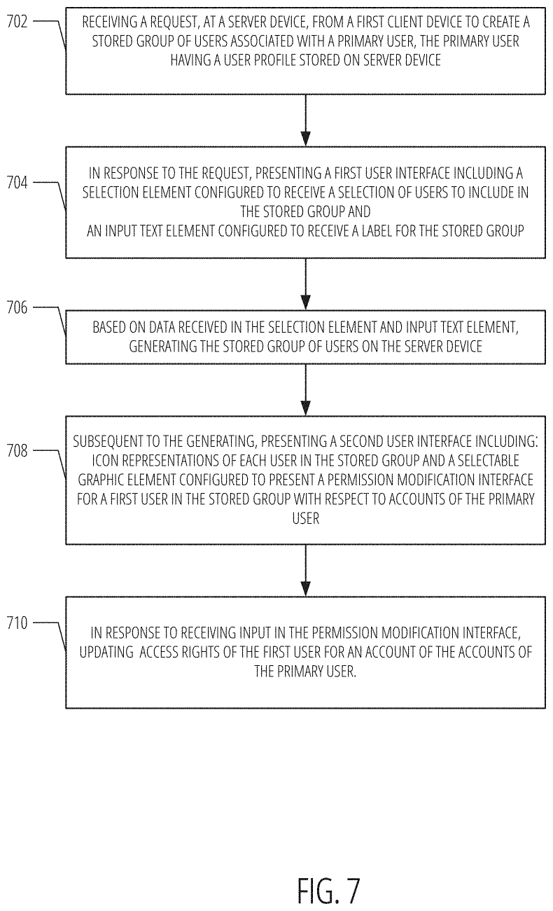

FIG. 7 is a flowchart illustrating operations of a method to generate group access rights for an account, according to various examples. The method is represented as a set of blocks that describe operations 702 to 710. The method may be embodied in a set of instructions stored in at least one computer-readable storage device of a computing device(s). A computer-readable storage device excludes transitory signals. In contrast, a signal-bearing medium may include such transitory signals. A machine-readable medium may be a computer-readable storage device or a signal-bearing medium. The computing device(s) may have one or more processors that execute the set of instructions to configure the one or more processors to perform the operations illustrated in FIG. 7. The one or more processors may instruct other component of the computing device(s) to carry out the set of instructions. For example, the computing device may instruct a network device to transmit data to another computing device or the computing device may provide data over a display interface to present a user interface. In some examples, performance of the method may be split across multiple computing devices using a shared computing infrastructure.

In various examples, the method at operation 702, may include receiving a request, at a server device, from a first client device to create a stored group of users associated with a primary user, the primary user having a user profile stored on server device. For example, the client device may be client device 104 and the server device may be application server 102 as depicted and discussed previously. An application may be executed on client device 104 which presents the user interfaces of the method, in various examples. The user profile may be stored as part of user accounts 120. The interfaces discussed for the method may be presented using group management 122, goal logic 126, and messaging component 124, in various examples.

In various examples, the method at operation 704, may include in response to the request, presenting a first user interface including a selection element configured to receive a selection of users to include in the stored group, and an input text element configured to receive a label for the stored group. For example, the user interface may present icon representations, such as profile pictures, of users associated with (e.g., in a contact list) the primary account where in clicking on a representation in an indication that the user should be added to the stored group. The label may be a name for the group. For example, in user interface 202 it may be seen that there are three different groups along with an option to manage groups. Upon clicking manage groups, an interface such as discussed with operation 704 may be presented. Another example of an interface that may be used to add users to a group is user interface 204. As seen within interface 204, there are options to add adults and children to an existing group.

In various examples, the method at operation 706, may include based on data received in the selection element and input text element, generating the stored group of users on the server device. For example, generating the stored group may include generating a data structure and storing it within data store 118. The data structure may include user identifications of each of the users in the group along with an indication (e.g., a flag) that the user currently using the application is the primary user.

In various examples, the method at operation 708, may include subsequent to the generating, presenting a second user interface including icon representations of each user in the stored group, and a selectable graphic element configured to present a permission modification interface for a first user in the stored group with respect to accounts of the primary user. For example, user interface 204 includes gear icons which may be used to edit the permissions. The permission modification interface may display identifications of the various accounts of the user, such as a checking account and a savings account. Further presented may be a drop-down menu (or other user input element) that allows for selection of authorize viewing or deny viewing. The permission modification interface may be specific to the user upon which the gear icon was clicked, in various examples.

In various examples, the method at operation 710, may include in response to receiving input in the permission modification interface, updating access rights of the first user for an account of the accounts of the primary user. For example, within the group data structure, there may be additional parameter stored for the permissions as set by the primary user with respect to their accounts and the users that are part of the stored group.

The method may also include presenting a third user interface including an identifier of a goal of the primary user, a status of the goal, and an icon representation of users in the stored group that have contributed towards the goal. For example, a user interface such as user interface 302 may be presented. The status of the goal may refer to the graphical representation that visually depicts how close the goal is to completion as well as a numerical representation of how much is remaining of the goal.

The method may also include receiving an access rights change request from a client device associated with the primary user to remove goal status access rights of the goal for a second user in the stored group, and in response to the access rights change request, updating the viewing access rights of the second user with respect to the goal. For example, as with permissions for an account, a goal permission access modification interface may be presented that lists the goals of the user and whether or not various contexts may view the status of the goal. Intermediate access rights may also be granted such as indicating the completion percentage, but not the dollar amount of a goal.

The method may also include receiving a goal viewing request from a second user, the second user being in the group of users, to view the goal of the primary user. In response to the goal viewing request, the method may include presenting a fourth user interface identifying contributions made by other users in the group of users to the goal of the primary user. For example, the fourth user interface may be similar to user interface 302. The method may also include receiving a contribution amount from the second user towards the goal, and in response, transmitting a notification to each user in the group of users, and adding a message in a group chat messaging interface indicating the contribution amount. For example, an interface such as 308 may be used for the notification and user interface 310 for the message in a group chat.

The method may also include includes receiving a collaborative goal request to create a collaborative goal from the primary user. The collaborative goal request may be received at a server device such as application server 102 based on a user clicking a user interface element presented on a client device. A collaborative goal may be a goal that may be shared by many users such as for investing in property, funding a trip, starting a business, investing in education, etc. An example of some of the options for collaborative goals is presented in user interface 404.

The method may also include in response to the collaborative goal request, presenting a third user interface including a first user selection portion identifying contacts of the primary user that have accounts on the server device, and a second user selection portion identifying contacts of the primary user that do not have accounts on the server device. For example, user interface 402 presents a segmented interface that includes a portion that presents contacts that also have accounts on application server 102, as well as another portion of context that do not (with the ability to invite them to join the goal).

The method may also include based on user selections made in the first user selection portion and the second user selection portion, generating a collaborative group of users on the server device. The method may also include transmitting invitation requests to users associated with the user selections. The collaborative group of users may be generated in a similar manner as discussed above for the group of users. Thus, a data structure may be created which identifies the users—their respective joining status—and any individual settings that each of the users may have.

The method may also include presenting a fourth user interface including, with respect to the collaborative goal, a collaborative goal amount input element, and an individual goal amount input element. The fourth user interface may be one such as user interface 408.

The method may also include further includes receiving a request from the primary user to view a status of the collaborative goal; and in response presenting a collaborative goal overview user interface including a combined contribution amount of the collaborative group of users, and a percentage amount contribution of each individual in the collaborative group of users. The collaborative goal overview user interface may be one such as user interface 410.

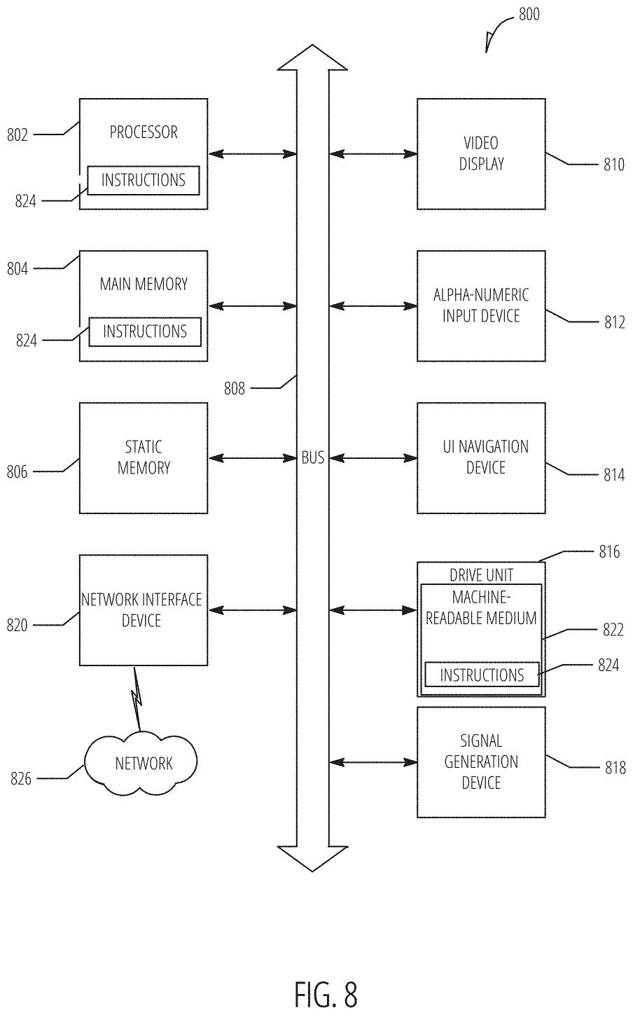

FIG. 8 is a block diagram illustrating a machine in the example form of a computer system 800, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 800 includes at least one processor 802 (e.g., a central processing unit (CPU), a graphics processing unit (GPU) or both, processor cores, compute nodes, etc.), a main memory 804 and a static memory 806, which communicate with each other via a link 808 (e.g., bus). The computer system 800 may further include a video display unit 810, an input device 812 (e.g., a keyboard), and a user interface (UI) navigation device 814 (e.g., a mouse). In one embodiment, the video display unit 810, input device 812 and UI navigation device 814 are incorporated into a touch screen display. The computer system 800 may additionally include a storage device 816 (e.g., a drive unit), a signal generation device 818 (e.g., a speaker), a network interface device 820, and one or more sensors (not shown), such as a global positioning system (GPS) sensor, compass, accelerometer, or other sensor.

The storage device 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804, static memory 806, and/or within the processor 802 during execution thereof by the computer system 800, with the main memory 804, static memory 806, and the at least one processor 802 also constituting machine-readable media.

While the machine-readable medium 822 is illustrated in an example embodiment to be a single medium, the term “machine-readable medium” may include a single medium or multiple media (e.g., a centralized or distributed database, and/or associated caches and servers) that store the instructions 824. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, 4G LTE/LTE-A or WiMAX networks, and 5G). The term “transmission medium” shall be taken to include any intangible medium that is capable of storing, encoding, or carrying instructions for execution by the machine, and includes digital or analog communications signals or other intangible medium to facilitate communication of such software.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

What is claimed is:

1. A method comprising:
receiving a request, at a server device, from a first client device to create a stored group of users associated with a primary user, the primary user having a user profile stored on server device;
in response to the request, presenting a first user interface including:
a selection element configured to receive a selection of users to include in the stored group; and
an input text element configured to receive a label for the stored group;
based on data received in the selection element and input text element, generating the stored group of users on the server device;
subsequent to the generating, presenting a second user interface including:
icon representations of each user in the stored group; and
a selectable graphic element configured to present a permission modification interface for a first user in the stored group with respect to accounts of the primary user; and
in response to receiving input in the permission modification interface, updating access rights of the first user for an account of the accounts of the primary user.

2. The method of claim 1, further comprising:
presenting a third user interface including:
an identifier of a goal of the primary user;
a status of the goal; and
an icon representation of users in the stored group that have contributed towards the goal.

3. The method of claim 2, further comprising:
receiving an access rights change request from a client device associated with the primary user to remove goal status access rights of the goal for a second user in the stored group; and
in response to the access rights change request, updating viewing access rights of the second user with respect to the goal.

4. The method of claim 2, further comprising:
receiving a goal viewing request from a second user, the second user being in the group of users, to view the goal of the primary user;
in response to the goal viewing request, presenting a fourth user interface, the fourth user interface identifying contributions made by other users in the group of users to the goal of the primary user;
receiving a contribution amount from the second user towards the goal; and
in response to receiving the contribution:
transmitting a notification to each user in the group of users; and
adding a message in a group chat messaging interface indicating the contribution amount.

5. The method of claim 1, further comprising:
receiving a collaborative goal request to create a collaborative goal from the primary user;
in response to the collaborative goal request, presenting a third user interface including:
a first user selection portion identifying contacts of the primary user that have accounts on the server device; and
a second user selection portion identifying contacts of the primary user that do not have accounts on the server device;
based on user selections made in the first user selection portion and the second user selection portion, generating a collaborative group of users on the server device; and
transmitting invitation requests to users associated with the user selections.

6. The method of claim 5, further comprising:
presenting a fourth user interface including, with respect to the collaborative goal:
a collaborative goal amount input element; and
an individual goal amount input element.

7. The method of claim 6, further comprising:
receiving a request from the primary user to view a status of the collaborative goal; and in response:
presenting a collaborative goal overview user interface including:
a combined contribution amount of the collaborative group of users; and
a percentage amount contribution of each individual in the collaborative group of users.

8. A non-transitory computer-readable medium comprising instructions, which when executed by a processing unit, configure the processing unit to perform operations comprising:
receiving a request, at a server device, from a first client device to create a stored group of users associated with a primary user, the primary user having a user profile stored on server device;
in response to the request, presenting a first user interface including:
a selection element configured to receive a selection of users to include in the stored group; and
an input text element configured to receive a label for the stored group;
based on data received in the selection element and input text element, generating the stored group of users on the server device;
subsequent to the generating, presenting a second user interface including:
icon representations of each user in the stored group; and
a selectable graphic element configured to present a permission modification interface for a first user in the stored group with respect to accounts of the primary user; and
in response to receiving input in the permission modification interface, updating access rights of the first user for an account of the accounts of the primary user.

9. The non-transitory computer-readable medium of claim 8, wherein the instructions, which when executed by the processing unit, further configure the processing unit to perform operations comprising:
presenting a third user interface including:
an identifier of a goal of the primary user;
a status of the goal; and
an icon representation of users in the stored group that have contributed towards the goal.

10. The non-transitory computer-readable medium of claim 9, wherein the instructions, which when executed by the processing unit, further configure the processing unit to perform operations comprising:
receiving an access rights change request from a client device associated with the primary user to remove goal status access rights of the goal for a second user in the stored group; and
in response to the access rights change request, updating viewing access rights of the second user with respect to the goal.

11. The non-transitory computer-readable medium of claim 9, wherein the instructions, which when executed by the processing unit, further configure the processing unit to perform operations comprising:
receiving a goal viewing request from a second user, the second user being in the group of users, to view the goal of the primary user;
in response to the goal viewing request, presenting a fourth user interface, the fourth user interface identifying contributions made by other users in the group of users to the goal of the primary user;
receiving a contribution amount from the second user towards the goal; and
in response to receiving the contribution:
transmitting a notification to each user in the group of users; and
adding a message in a group chat messaging interface indicating the contribution amount.

12. The non-transitory computer-readable medium of claim 8, wherein the instructions, which when executed by the processing unit, further configure the processing unit to perform operations comprising:
receiving a collaborative goal request to create a collaborative goal from the primary user;
in response to the collaborative goal request, presenting a third user interface including:
a first user selection portion identifying contacts of the primary user that have accounts on the server device; and
a second user selection portion identifying contacts of the primary user that do not have accounts on the server device;
based on user selections made in the first user selection portion and the second user selection portion, generating a collaborative group of users on the server device; and
transmitting invitation requests to users associated with the user selections.

13. The non-transitory computer-readable medium of claim 12, wherein the instructions, which when executed by the processing unit, further configure the processing unit to perform operations comprising:
presenting a fourth user interface including, with respect to the collaborative goal:
a collaborative goal amount input element; and
an individual goal amount input element.

14. The non-transitory computer-readable medium of claim 13, wherein the instructions, which when executed by the processing unit, further configure the processing unit to perform operations comprising:
receiving a request from the primary user to view a status of the collaborative goal; and in response:
presenting a collaborative goal overview user interface including:
a combined contribution amount of the collaborative group of users; and
a percentage amount contribution of each individual in the collaborative group of users.

15. A system comprising:
a processing unit;
a storage device comprising instructions, which when executed by the processing unit, configure the processing unit to perform operations comprising:
receiving a request, at a server device, from a first client device to create a stored group of users associated with a primary user, the primary user having a user profile stored on server device;
in response to the request, presenting a first user interface including:
a selection element configured to receive a selection of users to include in the stored group; and
an input text element configured to receive a label for the stored group;
based on data received in the selection element and input text element, generating the stored group of users on the server device;
subsequent to the generating, presenting a second user interface including:
icon representations of each user in the stored group; and
a selectable graphic element configured to present a permission modification interface for a first user in the stored group with respect to accounts of the primary user; and
in response to receiving input in the permission modification interface, updating access rights of the first user for an account of the accounts of the primary user.

16. The system of claim 15, wherein the instructions, which when executed by the processing unit, further configure the processing unit to perform operations comprising:
presenting a third user interface including:
an identifier of a goal of the primary user;
a status of the goal; and
an icon representation of users in the stored group that have contributed towards the goal.

17. The system of claim 16, wherein the instructions, which when executed by the processing unit, further configure the processing unit to perform operations comprising:
receiving an access rights change request from a client device associated with the primary user to remove goal status access rights of the goal for a second user in the stored group; and
in response to the access rights change request, updating viewing access rights of the second user with respect to the goal.

18. The system of claim 16, wherein the instructions, which when executed by the processing unit, further configure the processing unit to perform operations comprising:
receiving a goal viewing request from a second user, the second user being in the group of users, to view the goal of the primary user;
in response to the goal viewing request, presenting a fourth user interface, the fourth user interface identifying contributions made by other users in the group of users to the goal of the primary user;
receiving a contribution amount from the second user towards the goal; and
in response to receiving the contribution:
transmitting a notification to each user in the group of users; and
adding a message in a group chat messaging interface indicating the contribution amount.

19. The system of claim 15, wherein the instructions, which when executed by the processing unit, further configure the processing unit to perform operations comprising:
receiving a collaborative goal request to create a collaborative goal from the primary user;
in response to the collaborative goal request, presenting a third user interface including:
a first user selection portion identifying contacts of the primary user that have accounts on the server device; and
a second user selection portion identifying contacts of the primary user that do not have accounts on the server device;
based on user selections made in the first user selection portion and the second user selection portion, generating a collaborative group of users on the server device; and
transmitting invitation requests to users associated with the user selections.

20. The system of claim 19, wherein the instructions, which when executed by the processing unit, further configure the processing unit to perform operations comprising:
presenting a fourth user interface including, with respect to the collaborative goal:
a collaborative goal amount input element; and
an individual goal amount input element
